(19) United States
(12) Patent Application Publication
(10) Pub. No.: US 2012/0093074 A1
(43) Pub. Date: Apr. 19, 2012

(54) Local breakout with local gateway for mobile users

(75) Inventors: Jussi-Pekka Sairanen, Saratoga, CA (US); Meghana Sahasrabudhe, Sunnyvale, CA (US); Naheed Vora, Santa Clara, CA (US); Yinghua Ye, Santa Clara, CA (US)

(73) Assignee: Nokia Siemens Networks Oy

(21) Appl. No.: 12/925,208

(22) Filed: Oct. 15, 2010

(51) Int. Cl. H04W 40/00

(52) U.S. Cl. 370/328

(57) ABSTRACT

A user equipment UE context is stored in a local memory including a session context for a breakout data session. The session context comprises a source internet protocol IP address, a destination IP address, an identifier of a former local breakout gateway LBGW and an identifier of a new LBGW. The former LBGW receives first traffic originating from the destination IP address and addressed to the source IP address, and uses the session context to forward the first traffic from the former LBGW to the new LBGW via a first tunnel. There is thus a globally routable IP address for the session context that need not change when the UE moves from one LBGW to another. Embodiments are detailed for routing through more than two LBGWs, and for when the UE initiates another breakout data session on the new LBGW ion addition to the aforesaid breakout data session.

### TECHNICAL FIELD

The exemplary and non-limiting embodiments of this invention relate generally to wireless communication systems, methods, devices and computer programs and, more specifically relate to local breakout and user mobility using network address translation.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

3GPP third generation partnership project

BTS base transceiver station (of a cellular system)

DL downlink (toward the UE)

EPC evolved packet core

E-UTRAN evolved UTRAN (LTE)

IP internet protocol

LBGW local breakout gateway

LTE long term evolution

MM/MME mobility management/mobility management entity

RRC radio resource control

UE user equipment

UL uplink (from the UE)

UTRAN universal terrestrial radio access network

Increasing demands for higher data volume across a higher number of wireless network subscribers is driving a trend toward utilizing non-cellular systems for certain data transmission needs which in the past were met strictly by the cellular systems. This is termed local breakout, where a cellular network subscriber utilizes some non-cellular mechanism for at least some of its data needs. The non-cellular on/off ramp for this data is generally termed a packet data network gateway PGW or a LBGW, and may be embodied for example as a WiFi, WLAN or Bluetooth access node through which IP traffic is ported to and from a mobile user equipment.

Local breakout offers a network operator a means to decrease the burden of data traffic on its network. The LBGW or breakout point becomes an anchoring point for the UE's data traffic. Long data sessions such as for streaming movies or extended voice over Internet protocol VoIP voice calls pose a problem for this setup for mobile users/UEs which move from one LBGW to another. Consider FIG. 1. Coverage areas of the cellular BTSs are approximated by dashed lines. A UE under control of BTS-1 has an ongoing local breakout through LBGW-1. When the UE moves to a new BTS-2 the sessions that it started at UE-1 cannot be moved; in the prior art the sessions must be terminated and restarted to route through LBGW-2, or the data packets are transported between the new BTS-2 and the old BTS-1 which is the anchoring point of the sessions. This is true whether the new BTS-2 is under the same SGW-1 or a different SGW-2, or whether the UE is moving between its home cellular network and a visiting network or between two visiting cellular networks.

Some proposals for local breakout have the breakout network assigning an IP address to the UE. It is then up to the UE to decide whether to pass its traffic to the EPC of the cellular network (the SGW-1 or the MME-1 of FIG. 1) or to the breakout network (the LBGW-1 of FIG. 1). Here, the mobility of the UE causes problems for the breakout. When the UE moves to another location, either it has to acquire a new breakout IP address which will terminate all existing connections with the first breakout access point LBGW-1, or it will need to tunnel its breakout data traffic to the new location from the existing anchoring point which in the case of FIG. 1 would be from BTS-1 to BTS-2.

Additionally, networks supporting breakout traffic is a break with past practice because it potentially undermines a revenue stream for the network. Certain networks have policies which take this new revenue picture into account,, and allowing the UE to always select which sessions to offload via a breakout network may be contrary to those or other network operator policies.

Another option for local breakout mobility is to allow the LBGW to make the breakout decisions which arise from UE mobility. This also tends to result in the UE data sessions being terminated when the UE moves to another BTS.

### SUMMARY

The foregoing and other problems are overcome, and other advantages are realized, by the use of the exemplary embodiments of this invention.

In a first aspect thereof the exemplary embodiments of this invention provide a method, comprising: storing in a computer readable memory a user equipment context comprising for at least one breakout data session a source internet protocol address, a destination internet protocol address, an identifier of a former local breakout gateway and an identifier of a new local breakout gateway; receiving at the former local breakout gateway first traffic originating from the destination internet protocol address and addressed to the source internet protocol address; and using the user equipment context to forward the first traffic from the former local breakout gateway to the new local breakout gateway via a first tunnel.

In a second aspect thereof the exemplary embodiments of this invention provide an apparatus, comprising at least one processor, and at least one memory including computer program code and storing a user equipment context comprising for at least one breakout data session a source Internet protocol address, a destination internet protocol address, an identifier of a former local breakout gateway and an identifier of a new local breakout gateway. The at least one memory and the computer program code are configured, with the at least one processor, to cause the apparatus at least to perform: in response to receiving first traffic originating from the destination internet protocol address and addressed to the source internet protocol address; using the user equipment context to forward the first traffic from the former local breakout gateway to the new local breakout gateway via a first tunnel.

In a third aspect thereof the exemplary embodiments of this invention provide a memory storing a program of computer readable instructions that when executed by a processor result in actions comprising: storing a user equipment context comprising for at least one breakout data session a source internet protocol address, a destination internet protocol address, an identifier of a former local breakout gateway and an identifier of a new local breakout gateway; receiving at the former local breakout gateway first traffic originating from the destination internet protocol address and addressed to the source internet protocol address; and using the user equipment context to forward the first traffic from the former local breakout gateway to the new local breakout gateway via a first tunnel.

These and other aspects of the invention are detailed more fully below.

### BRIEF DESCRIPTION OF THE DRAWINGS

FIG. 1 shows various cellular and breakout network nodes in relation to a UE moving amongst them in conventional local breakouts.

FIG. 2 is a schematic diagram showing traffic ported to a UE through a first local breakout gateway using network address translation.

FIG. 3 is a schematic diagram similar to FIG. 2 but where the UE has moved under a second local breakout gateway and showing traffic routed through the first local breakout gateway to the second local breakout gateway and eventually to the UE according to an exemplary embodiment of the invention

FIG. 4 shows a simplified block diagram of certain apparatus according to various exemplary embodiments of the invention.

FIG. 5 is a logic flow diagram that illustrates the operation of a method, and a result of execution of computer program instructions embodied on a computer readable memory, in accordance with the exemplary embodiments of this invention.

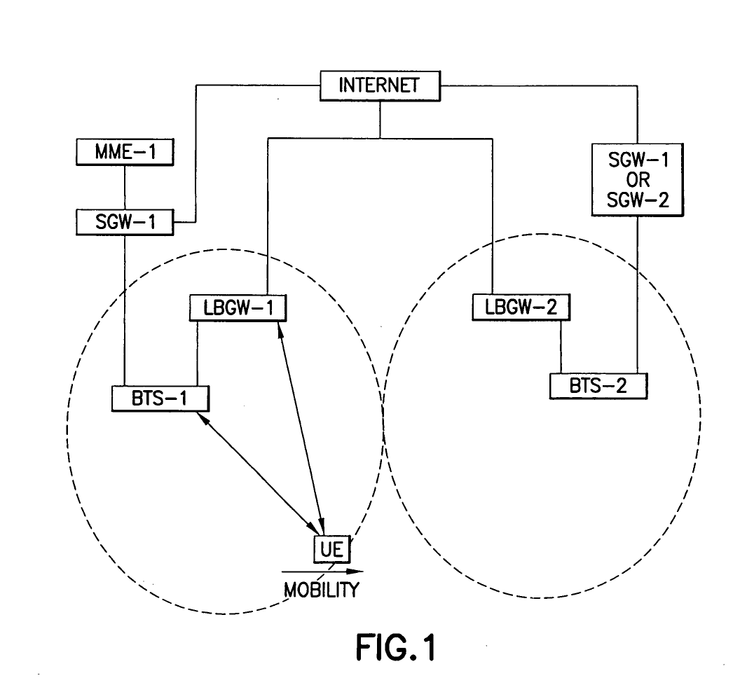

### DETAILED DESCRIPTION

The exemplary breakout mechanism minimizes the undesirable horizontal routing of UE data sessions between cellular BTSs. When a UE moves to a new LBGW and starts new data sessions, the outbound packets are handed to the NAT on the new LBGW and thus inbound packets also arrive at the new NAT making the path optimized for new sessions.

The LBGW can select which user sessions are offloaded through the breakout network. These sessions would not be routed through the operator's private mobile network (e.g., the cellular network/BTSs) but rather they would be directed right into the open internet.

As a starting point, assume there is a LBGW which initiates the UE's breakout data session. There is stored in a computer readable memory of the LBGW a UE context, which includes for each of these breakout data sessions a session context which comprises a source IP address, a destination IP address, and an identifier of the LBGW itself which is where this session was initiated. For convention assume that for this session context the UE is assigned the source IP address and the serving internet site carries the destination IP address. Data over this session passes between source and destination address in both directions directly through the LBGW. When the data breakout session is established originally through this same LBGW there are no other anchoring points or network nodes involved.

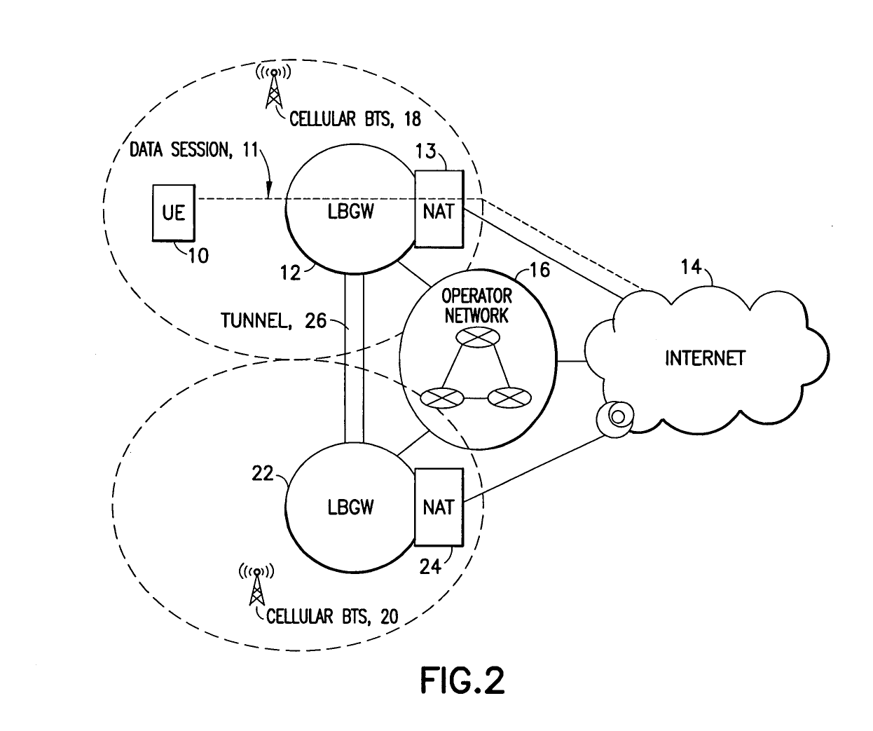

FIG. 2 illustrates this initial condition. The UE 10 established a first data session 11 via the LBGW 12 which uses its memory at which is stored the network address translation tables NAT 13 that include the UE context which has the session context for this first data session 11. Traffic on the first data session 11 routes between the UE and the end-point located on the internet 14. This is a data breakout session so the first data session 11 does not go through the private (cellular) operator network 16, despite the fact that the same UE 10 may be under control of a BTS 18 on that private operator network 16. The operator network 16 includes both BTSs 18 and 20 but is shown offset for clarity of description.

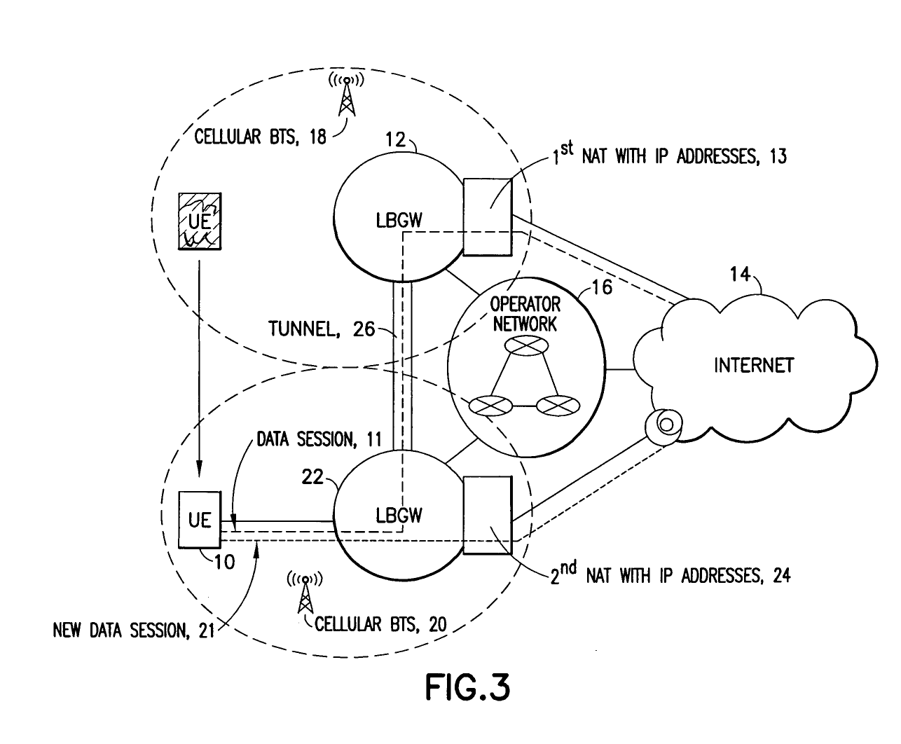

Now at FIG. 3 the UE has moved and attached to another LBGW 22. For convenience term LBGW 12 the former LBGW and LBGW 22 the new LBGW. The first data session 11 is still anchored through the former LBGW 12. There is a tunnel 26 established between the former LBGW 12 and the new LBGW 22. At handoff of the UE 10 the former LBGW 12 sends to the new LBGW 22 the UE context along with a list of the UE's breakout sessions. Both the former 12 and the new 22 LBGW update their session contexts to reflect that handover. As will be seen with FIG. 3, if the UE initiates a new session 21 with the new LBGW 22 those new sessions are not propagated to the former LBGW 12. As with FIG. 2, concerning the breakout session 11 it matters not whether the UE 10 has also handed over to a new BTS 20 on the operator network 16.

Now that the UE 10 is attached to the new LBGW 22 and the session context at the former LBGW 12 is updated to reflect an identifier of the new LBGW 22 for the first data session 11, there is received at the former LBGW 12 first traffic originating from the destination internet protocol address on the internet 14 which is addressed to the source internet protocol address. That source IP address is assigned to the UE 10 and maintained for the UE for the first session 11 after the UE changes its attachment. Then the former LBGW 12 uses the UE session context to forward traffic on the first session 11 from the former LBGW 12 to the new LBGW 22 via a first tunnel 26.

The above traffic was downlink toward the UE 10, and may conveniently be termed first traffic on the first data session 11. Second traffic on the first data session 11 is then uplink traffic which flows similarly after the new attachment at FIG. 3. The UE 10 sends its UL breakout traffic on the first session 11 to the new LBGW 22 whose locally stored session context for the UE context concerning the first session 11 has the same information as the former LBGW's session context; namely the source and destination IP addresses and ports, and identifiers for the former and new LBGWs which form the tunnel ends. The new LBGW 22 receives this second (uplink) traffic from the UE, checks the session context for the first data session 11 and forwards this second traffic through the tunnel 26 to the former LBGW 12.

The former LBGW 12 receives via the first tunnel 26 from the new LBGW 22 that second (uplink) traffic on data session 11, which originates from the source internet protocol address (the UE 10 in this example) and which is addressed to the destination internet protocol address (a website), and directs that second traffic to a router 24 on the internet for delivery to the destination address. Each of the LBGWs 12, 22 have the same session context for data session 11 in their respective NATs 13, 24: the source and destination IP addresses, identifiers of the tunnel endpoints (the LBGWs 12, 22) for the tunnel 26 between them, and the ports for the session 11 which shares a tunnel 26 between them.

Now consider FIG. 3 from the perspective of the LBGW 12 if the UE attached to the former LBGW 12 after moving from an original LBGW (not shown) at which the UE first established the first data session 11. In this example the UE 10 has attached to three different LBGWs while maintaining the same first data session 11 (which unlike FIGS. 2-3 was anchored at the original LBGW); an original LBGW followed by the former LBGW 12 followed by the new LBGW 22. In this example there is also a second tunnel (not shown) between the former LBGW 12 and the original LBGW (not shown).

In this example the UE context and its session context for this first data session 11 at the former LBGW 12 further includes an identifier for the original LBGW. From the perspective of the former LBGW 12 the first traffic (DL to the UE 10) is received from the original LBGW via the second tunnel and forwarded to the new LBGW 22 via the first tunnel 26. The second traffic (UL from the UE), which originates from the source internet protocol address and which is addressed to the destination internet protocol address, is received at the former LBGW 12 via the first tunnel 26 from the new LBGW 22 and forwarded to the original LBGW (not shown) via the second tunnel (not shown).

Note that in the example above with a chain of three LBGWs, the three NATs for the first data session are not all identical; the originating LBGW need not have knowledge of the new LBGW 22 and vice versa, since those two nodes have no tunnel directly between them. The UE session identifiers for each node's session context are maintained on either side of the tunnel at the respective LBGWs. A tunnel 26 is created between the old 12 and new 22 LBGW and the session context information is transferred to the new LBGW 22, which enables the original session to be maintained at the original LBGW.

As the UE moves about in the network new tunnels would be opened for the sessions between LBGWs as noted above. Depending on UE mobility, a long-lived session may form a chain of tunnels between the UE's current attachment point and the LBGW where the session was originated. Since the UE data sessions are usually relatively short-lived the data forwarding chains should normally not extend through too many LBGWs. But to prevent them from growing too long in an exemplary embodiment there may be defined a maximum hop count for a given breakout data session, after which the UE 10 would be forced to re-initialize the session to a new LBGW.

If a UE moves back to a LBGW which is forwarding a session for it to another LBGW, in an exemplary embodiment the extra loop is cut out so that the same packets on that session in no case pass through any individual LBGW more than one time. So for example if we assume from the three LBGW example above that the UE moves again from the new LBGW 22 to the original LBGW, traffic on the first session goes between the UE and the internet via the original LBGW and is no longer passed through the former 12 or new 22 LBGWs.

Each session is anchored to the LBGW where it was initialized. A highly mobile UE can have different sessions anchored to a number of different LBGWs simultaneously. FIG. 3 illustrates this principle in that a second session 21 is established at the new LBGW 22, with the UE again as the source IP address and some other internet site as the destination address. The anchor for this new data breakout session 21 is the LBGW 22, hence this session does not pass through the former LBGW 12. But the UE 10 is still maintaining the first data session 11 which is anchored at the former LBGW 12, so at FIG. 3 the single UE 10 has two data sessions 11, 21 anchored at two different LBGWs 12 22. From the perspective of the former LBGW 12, unless the UE 10 moves back and re-attaches to LBGW 12, traffic on a new data session 21 which is established between the UE 10 and the new LBGW 22 after the UE 10 attaches to the new LBGW 22 does not pass through the former LBGW 12 and there is no session context for that new session 21 in the UE context stored at the former LBGW 12. The LBGWs 12, 22 only share the context of sessions that are anchored on the other LBGW; if a UE is attached to/resides on the same LBGW where the session is anchored (e.g., session 21 on LBGW 22 in FIG. 3) then there is no need to transfer the session context to the other LBGW.

The use of the NAT IP address for the UE, which is maintained in the NATs despite UE mobility, anchors the data breakout session to a globally routable network node (e.g., the LBGW 12 for session 11 and the LBGW 22 for session 21) seamlessly regardless of where the UE moves.

In an exemplary embodiment of the invention there is additionally a policy enforcement module at the LBGW 12 for the session(s) 11 it anchors that is used for a) selecting which data sessions to breakout and b) redirecting packets belonging to UEs that have moved elsewhere to the right destinations. As the UE moves to another LBGW, a tunnel is created between the new LBGW 22 and the old LBGW 12 to allow the user data session 11 to continue.

In accordance with the above exemplary embodiments no modifications are needed for implementation in the UE because there is no need for the UE to carry two IP addresses (i.e. one for standard EPC traffic and one for breakout traffic which changes with UE mobility). That is, in an exemplary embodiment the IP address for the UE is the same for cellular traffic and for breakout traffic. One technical effect of these exemplary embodiments is that the selection of which sessions to forward to the EPC or to breakout locally is on the LBGW 12, not the UE 10. This is the node which is configured with the network operator's policy rules, so the LBGW 12 is better suited to make the breakout decisions. Exemplary embodiments of the invention preserve session mobility, as breakout sessions are kept alive even when UE moves to a new network.

Further, in certain exemplary embodiments there is no eternally fixed anchor point for the UE's data sessions. In some breakout proposals the UE's breakout point/LBGW remains the same for the time the UE is connected to the network. If the UE moves great distances the benefits of local breakout could be lost in those proposals to the multi-hop data forwarding needed to connect the UE to its sole anchoring LBGW. But in the exemplary embodiments detailed above this is avoided because only the individual data sessions' end points are fixed, and new sessions get a breakout point/LBGW as close to the UE as possible when those new sessions are initiated. Further, some exemplary embodiments noted above may also limit how far the multi-hops can extend in the case of a very mobile UE or a very long session.

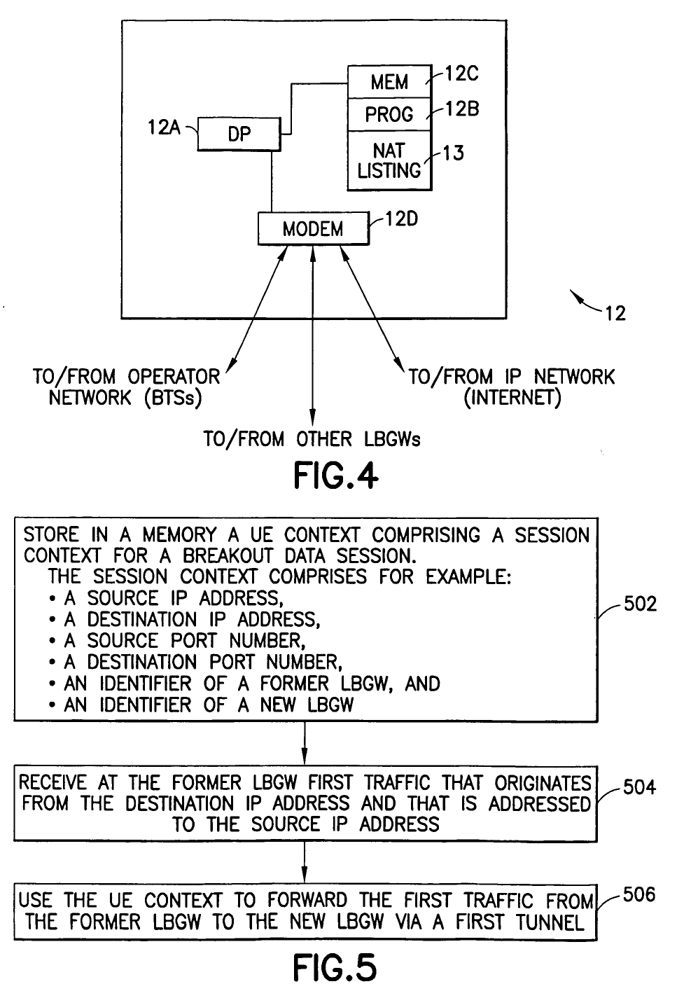

Reference is made to FIG. 4 for illustrating a simplified block diagram of an access node in the position of the LBGW 12 of FIGS. 2-3 that is suitable for use in practicing the exemplary embodiments of this invention. In FIG. 4 the LBGW 12 is adapted for communication over a wireless link with an apparatus such as a mobile communication device which above is referred to as a UE 10, and also configured to communicate directly to the internet without going through any operator network. The LBGW 12 includes a controller, such as a computer or a data processor (DP) 12A, a computer-readable memory medium embodied as a memory (MEM) 12C that stores a program of computer instructions (PROG) 12B and the UE context with the context for the relevant individual sessions and the NAT listing 13 detailed above, and a suitable modem 12D which for wireless links also includes a radio frequency (RF) transmitter and receiver for bidirectional wireless communications with the UE 10 via one or more antennas.

At least one of the PROGs 12B is assumed to include program instructions that, when executed by the associated DP, enable the apparatus 12 to operate in accordance with the exemplary embodiments of this invention as detailed above. That is, the exemplary embodiments of this invention may be implemented at least in part by computer software executable by the DP 12A of the LBGW 12, or by hardware, or by a combination of software and hardware (and firmware).

The computer readable MEM 12C may be of any type suitable to the local technical environment and may be implemented using any suitable data storage technology, such as semiconductor based memory devices, flash memory, magnetic memory devices and systems, optical memory devices and systems, fixed memory and removable memory. The DP 12A may be of any type suitable to the local technical environment, and may include one or more of general purpose computers, special purpose computers, microprocessors, digital signal processors (DSPs) and processors based on a multicore processor architecture, as non-limiting examples.

FIG. 5 is a logic flow diagram that illustrates the operation of a method, and a result of execution of computer program instructions, in accordance with the exemplary embodiments of this invention. In accordance with these exemplary embodiments at block 502 there is stored in a computer readable memory a UE context comprising (by example) a session context for a breakout data session, in which the session context comprises a source IP address and port number, a destination IP address and port number, an identifier fora former LBGW and an identifier for a new LBGW. At block 504 the former LBGW receives first traffic that originates from the destination IP address and that is addressed to the source IP address. And at block 506 the session context is used to forward the first traffic from the former LBGW to the new LBGW via a first tunnel.

The various blocks shown in FIG. 5 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof. Further, the specific systems, nodes and devices detailed for the exemplary embodiments above are exemplary and non-limiting to the broader teachings herein which may be employed in other radio access systems, current or yet to be developed, which allow local breakout.

1. A method, comprising:
storing in a computer readable memory a user equipment context comprising a session context for a breakout data session, in which the session context comprises a source internet protocol address, a destination internet protocol address, an identifier of a former local breakout gateway and an identifier of a new local breakout gateway;
receiving at the former local breakout gateway first traffic originating from the destination internet protocol address and addressed to the source internet protocol address; and
using the session context to forward the first traffic from the former local breakout gateway to the new local breakout gateway via a first tunnel.

2. The method according to claim 1, further comprising:
receiving at the former local breakout gateway via the first tunnel from the new local breakout gateway second traffic originating from the source internet protocol address and addressed to the destination internet protocol address; and
directing the second traffic to a router on the internet.

3. The method according to claim 1, in which the first traffic is received at the former local breakout gateway from an original local breakout gateway via a second tunnel;
and in which the session context further comprises an identifier of the original local breakout gateway;
the method further comprising:
receiving at the former local breakout gateway via the first tunnel from the new local breakout gateway second traffic originating from the source internet protocol address and addressed to the destination internet protocol address; and
forwarding the second traffic from the former local breakout gateway to the original local breakout gateway via the second tunnel.

4. The method according to claim 1, in which the new local breakout gateway is added to the stored session context, and the first tunnel is established, after the user equipment which is assigned the source internet protocol address changes attachment from the former local breakout gateway to the new local breakout gateway.

5. The method according to claim 1, in which the method is executed by the former local breakout gateway which is configured to provide direct connection between the user equipment and the internet;
the method further comprising the former local breakout gateway transferring the session context to the new local breakout gateway in correspondence with the user equipment changing attachment from the former local breakout gateway to the new local breakout gateway.

6. The method according to claim 5, in which traffic on a new data session, established between the user equipment and the new local breakout gateway after the user equipment attaches to the new local breakout gateway, does not pass through the former local breakout gateway.

7. The method according to claim 1, in which the computer readable memory further stores a breakout session policy filter which selectively filters which sessions of the user equipment are to be forwarded using the stored user equipment context.

8. An apparatus, comprising:
at least one processor; and
at least one memory including computer program code and storing a user equipment context comprising a session context for a breakout data session, in which the session context comprises a source internet protocol address, a destination internet protocol address, an identifier of a former local breakout gateway and an identifier of a new local breakout gateway;
the at least one memory and the computer program code configured, with the at least one processor, to cause the apparatus at least to perform:
in response to receiving first traffic originating from the destination internet protocol address and addressed to the source internet protocol address; using the session context to forward the first traffic from the former local breakout gateway to the new local breakout gateway via a first tunnel.

9. The apparatus according to claim 8, in which the at least one memory and the computer program code are configured with the at least one processor to cause the apparatus at least to further perform:
in response to receiving at the former local breakout gateway via the first tunnel from the new local breakout gateway second traffic originating from the source internet protocol address and addressed to the destination internet protocol address; directing the second traffic to a router on the internet.

10. The apparatus according to claim 8, in which the first traffic is received at the former local breakout gateway from an original local breakout gateway via a second tunnel;
and in which the session context further comprises an identifier of the original local breakout gateway;
and in which the at least one memory and the computer program code are configured with the at least one processor to cause the apparatus at least to further perform:
in response to receiving at the former local breakout gateway via the first tunnel from the new local breakout gateway second traffic originating from the source internet protocol address and addressed to the destination internet protocol address, forwarding the second traffic from the former local breakout gateway to the original local breakout gateway via the second tunnel.

11. The apparatus according to claim 8, in which the new local breakout gateway is added to the stored session context, and the first tunnel is established, after the user equipment which is assigned the source internet protocol address changes attachment from the former local breakout gateway to the new local breakout gateway.

12. The apparatus according to claim 8, in which the apparatus comprises the former local breakout gateway which is configured to provide direct connection between the user equipment and the internet;
and in which the at least one memory and the computer program code are configured with the at least one processor to cause the apparatus at least to further perform transferring the session context to the new local breakout gateway in correspondence with the user equipment changing attachment from the former local breakout gateway to the new local breakout gateway.

13. The apparatus according to claim 12, in which traffic on a new data session, established between the user equipment and the new local breakout gateway after the user equipment attaches to the new local breakout gateway, does not pass through the former local breakout gateway.

14. The apparatus according to claim 8, in which the memory further stores a breakout session policy filter which selectively filters which sessions of the user equipment are to be forwarded using the stored user equipment context.

15. A memory storing a program of computer readable instructions that when executed by a processor result in actions comprising:
storing a user equipment context comprising a session context for a breakout data session, in which the session context comprises a source internet protocol address, a destination internet protocol address, an identifier of a former local breakout gateway and an identifier of a new local breakout gateway;
receiving at the former local breakout gateway first traffic originating from the destination internet protocol address and addressed to the source internet protocol address; and
using the session context to forward the first traffic from the former local breakout gateway to the new local breakout gateway via a first tunnel.

16. The memory according to claim 15, further comprising:
receiving at the former local breakout gateway via the first tunnel from the new local breakout gateway second traffic originating from the source internet protocol address and addressed to the destination internet protocol address; and
directing the second traffic to a router on the internet.

17. The memory according to claim 15, in which the first traffic is received at the former local breakout gateway from an original local breakout gateway via a second tunnel;
and in which the session context further comprises an identifier of the original local breakout gateway;
the actions further comprising:
receiving at the former local breakout gateway via the first tunnel from the new local breakout gateway second traffic originating from the source internet protocol address and addressed to the destination internet protocol address; and
forwarding the second traffic from the former local breakout gateway to the original local breakout gateway via the second tunnel.

18. The memory according to claim 15, in which the new local breakout gateway is added to the stored session context, and the first tunnel is established, after the user equipment which is assigned the source internet protocol address changes attachment from the former local breakout gateway to the new local breakout gateway.

19. The memory according to claim 15, in which the memory and processor are disposed within the former local breakout gateway which is configured to provide direct connection between the user equipment and the internet;
the actions further comprising: the former local breakout gateway transferring the session context to the new local breakout gateway in correspondence with the user equipment changing attachment from the former local breakout gateway to the new local breakout gateway.

20. The memory according to claim 15, in which the memory further stores a breakout session policy filter which selectively filters which sessions of the user equipment are to be forwarded using the stored user equipment context.
